(19) United States
(12) Patent Application Publication
(10) Pub. No.: US 2003/0171979 A1
(43) Pub. Date: Sep. 11, 2003

(54) System and method for selecting and arranging products on a shelf

(76) Inventor: Margalyn Toi Jenkins, St. Louis, MO (US)

Correspondence Address: Evan R. Sotiriou, Harness, Dickey & Pierce, P.L.C., 7700 Bonhomme, Suite 400, St. Louis, MO, 63105, US

(21) Appl. No.: 10/279,529

(22) Filed: Oct. 24, 2002

Related U.S. Application Data
(60) Provisional application No. 60/363,154, filed on Mar. 11, 2002.

(51) Int. Cl. G06F 17/60

(52) U.S. Cl. 705/10; 705/35

(57) ABSTRACT

An interface that integrates electronic item assortment information and electronic shelf management information allows for easy analysis of changes to shelf sets for products. Financial information is updated based upon changes to a schematic representation of products to be displayed on the shelf. A comparison by category may be performed and a baseline used for comparison of proposed modifications.

### CROSS-REFERENCE TO RELATED APPLICATIONS

This application claims the benefit of U.S. Provisional Application No. 60/363,154 filed Mar. 11, 2002, the entire disclosure of which is incorporated herein by reference.

### FIELD OF THE INVENTION

The present invention relates generally to displaying products on a shelf for retail sale, and more particularly to a system for electronically integrating efficient item assortment and shelf management processes.

### BACKGROUND OF THE INVENTION

To maximize sales potential of products displayed for retail sale, it is often important to determine not only the specific products to display, but the location of the products on the shelf. Two related processes are involved when selecting and arranging products for display on a shelf. In particular, efficient item assortment planning and shelf management development are performed to make determinations as to the particular products for display and the configuration of that display (i.e., recommended shelf sets). Information regarding the shelf sets is then used to physically arrange the shelf.

Although the processes of efficient item assortment planning and shelf management development are related, the performance of these processes is typically very disparate. It is common for separate functions to be performed within each of these processes with very little inter-relation therebetween. This disconnectivity results in added cost, both in time and money when using the processes, for example, in determining retail merchandising tactics.

In today's manufacturing environment, introduction of new retail items is increasing dramatically, thereby requiring Stock Keeping Unit (SKU) management to increase performance (i.e., maximize retail sales). In order to maintain this high level of performance, daily management of shelf positioning (i.e., arrangement of products on display) is required, and includes, for example, efficient item assortment planning and shelf planogram development.

As recognized by the inventor hereof, there exists a need to integrate the efficient item assortment planning and shelf management development processes to streamline the overall process. It is desirable for such a system to provide information that is capable of easy updating for use in analysis and selecting products for display on a shelf to maximize sales and profitability.

### SUMMARY OF THE INVENTION

The present invention provides a system and method for integrating efficient item assortment planning and shelf management processes. Specifically, one embodiment of the present invention provides a method for integrating and displaying information to assist a user in selecting an assortment of retail products (e.g., animal food products) for display on a shelf and includes receiving electronic item assortment information for each of the retail products, receiving electronic shelf management information for each of the retail products, processing the received electronic item assortment information and electronic shelf management information to produce one of forecasted sales information and forecasted supply information, and displaying one of the forecasted sales information and forecasted supply information in combination with a representation of the assortment of retail products for display on the shelf. The method may include updating the forecasted sales information and forecasted supply information in response to a user's modification of the selection of the assortment of retail products for display on the shelf. Further, the method may include updating the forecasted sales information and forecasted supply information in response to a modification of the electronic item assortment information and/or the electronic shelf management information. The method may also include adding, deleting and/or changing representations of retail products for the assortment of retail products for display on the shelf and updating the forecasted sales information and forecasted supply information based upon the addition, deletion or modification to the representations of retail products.

Another embodiment of the present invention provides a method for assisting a user in selecting a plurality of products for display on a retail shelf using a computer and includes displaying on a display of the computer a representation of an arrangement of products selected for display on the retail shelf, receiving item assortment information and shelf management information relating to the products represented on the display, and displaying one of predicted financial information and predicted supply information relating to the representation of products in response to the received information. The may further include updating the displayed predicted financial information and predicted supply information in response to modification to the received information.

In yet another embodiment of the present invention a system for integrating and displaying information relating to an assortment of retail products is provided. The system includes an interface for receiving electronic item assortment information and electronic shelf management information, a processor configured to process the electronic item assortment information and electronic shelf management information to produce one of forecasted sales information and forecasted supply information for display in combination with a representation of the assortment of retail products, and a user input provided in connection with the interface and configured to allow modification of the received electronic item assortment information and electronic shelf management information resulting in updating of the displayed forecasted sales information and forecasted supply information.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of one embodiment of the present invention;

FIGS. 2(a) and 2(b) are screen shots of an interface provided in one embodiment of the present invention having integrated electronic item assortment information and electronic shelf management information;

FIG. 3 is a flow chart for the process for integrating electronic item assortment information and electronic shelf management information as illustrated in FIG. 2;

FIG. 4 is a flow chart for exporting product data for use by an interface of the present invention;

FIG. 5 is a flow chart for selecting hierarchy levels of the present invention;

FIG. 6 is a flow chart for selecting a planogram of the present invention;

FIG. 7 is a flow chart for opening and a planogram to be analyzed using the present invention;

FIG. 8 is a flow chart for importing updated data for use by an interface of the present invention;

FIG. 9 is a flow chart for updating information relating to products represented by the planogram;

FIG. 10 is a flow chart for showing changes to products represented by the planogram;

FIG. 11 is a flow chart for updating a dashboard panel of an interface of the present invention;

FIG. 12 is a flow chart for providing an exception report of the present invention;

FIG. 13 is a flow chart for selecting a baseline for use with the present invention;

FIG. 14 is a flow chart for changing the planogram and updating information displayed by the dashboard panel of the present invention based upon the change;

FIG. 15 is a flow chart for saving an updated planogram;

FIG. 16 is a flow chart for printing a report according to the present invention;

FIG. 17 is a flow chart of another embodiment of the present invention for integrating an item assortment process and a shelf management process;

FIG. 18 is a schematic diagram of an exemplary computer device for implementing the interface of FIG. 2;

FIG. 19 is a screen shot of a shelf worksheet of the present invention; and

FIG. 20 is a screen shot of an interface of the present invention showing a pull-down menu provided in connection therewith.

### DETAILED DESCRIPTION OF PREFERRED EMBODIMENTS

The following description of the preferred embodiments is merely exemplary in nature and is in no way intended to limit the invention, its application, or uses. Thus, although the present invention is disclosed in connection with selecting and arranging specific types of products for display on a retail shelf, it is not so limited, and different types of products may be selected and arranged on a shelf using the present invention.

In one embodiment of the present invention, a system and method is provided for integrating efficient item assortment planning and shelf management processes. Generally, item assortment data is imported into a shelf management tool (e.g., from Apollo Suite 8.0 shelf management tool available from Information Resources, Inc. of Ontario, Canada (“Apollo”)) to facilitate the process of maintaining existing shelf planograms (i.e., graphical representations of products arranged on a shelf) and provide financial reporting. This integrated process will streamline planning, including, for example, planogram recommendations and supporting financial data. Efficient item assortment data is imported into shelf management by selecting products to be added, deleted or retained, with information (e.g., financial information) provided showing the effects of the modifications (e.g., change in sales percentage or days of supply (DOS) on shelf of the products).

Essentially, the present invention provides information regarding products to be displayed on a shelf, including for example, ranking retailer sales versus market level sales. A determination as to which products to add, delete, and retain to maximize dollar sales may then be made based upon the information, which is updated based upon changes to the products selected, including the number of products selected. Automated import/export functionality is provided between the efficient item assortment process and the shelf management process.

An interface (e.g., a graphical user interface (GUI)) may be provided having click and drag capability with financial reporting based upon modifications to products selected. The interface allows for product selection to maximize retailer profitability and return on investment (e.g., increased category sales and share), shows the impact of new item introductions and reduces out of stock (OOS) products by balancing appropriate DOS information.

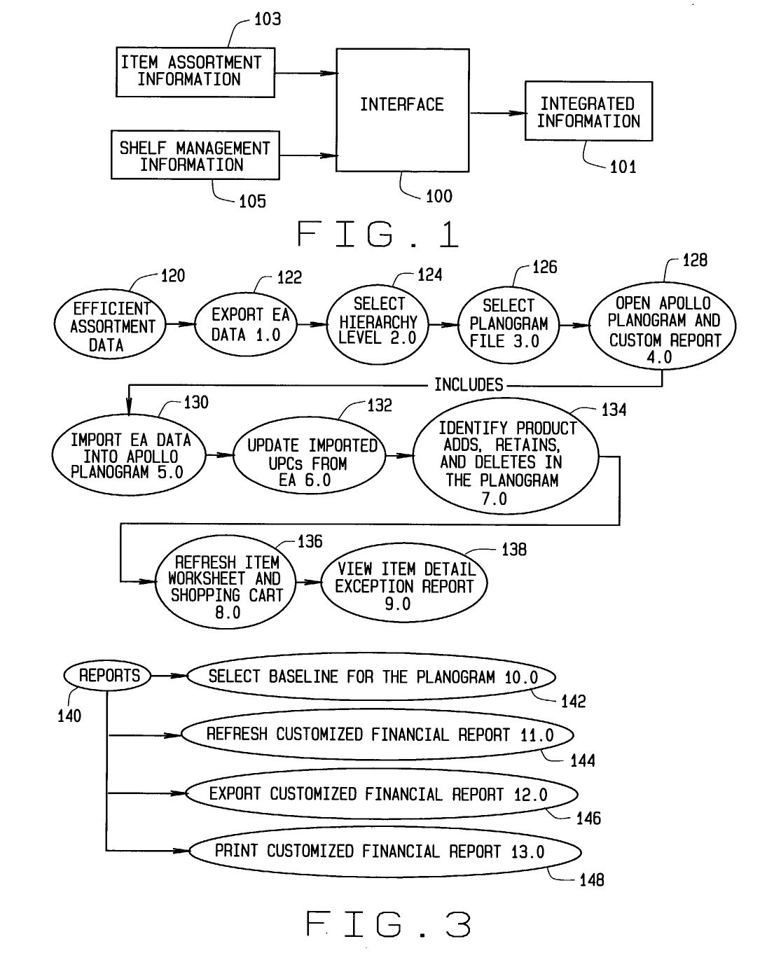

One preferred embodiment of the present invention shown generally in FIG. 1, provides an interface 100 that produces integrated electronic information 101, such as, financial information, including for example, predicted or forecasted sales information and/or predicted or forecasted supply information, about a group of products based generally upon electronic efficient item assortment information 103 (e.g., product information) and electronic shelf management information 105 (e.g., using a shelf management tool). Using the interface 100, a recommended shelf set (i.e., products for display on a particular shelf) is more easily and efficiently generated, thereby streamlining two related processes and reducing the time and cost of assessing the marketability of a particular group of products. Thus, new shelf sets may be created and existing shelf sets maintained and updated as needed.

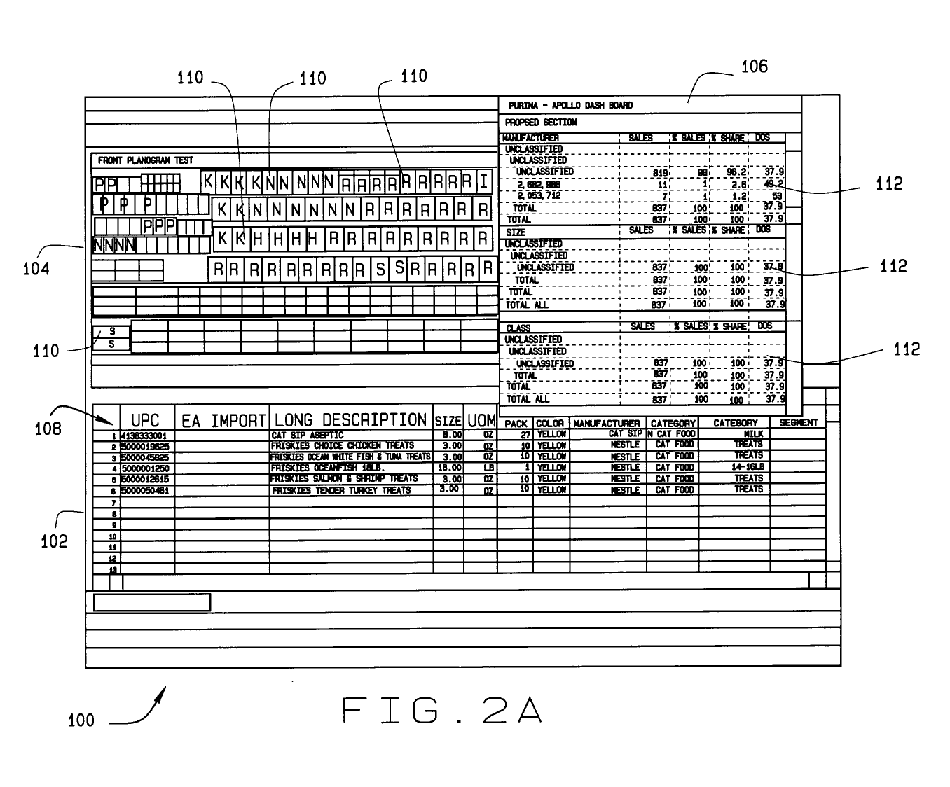

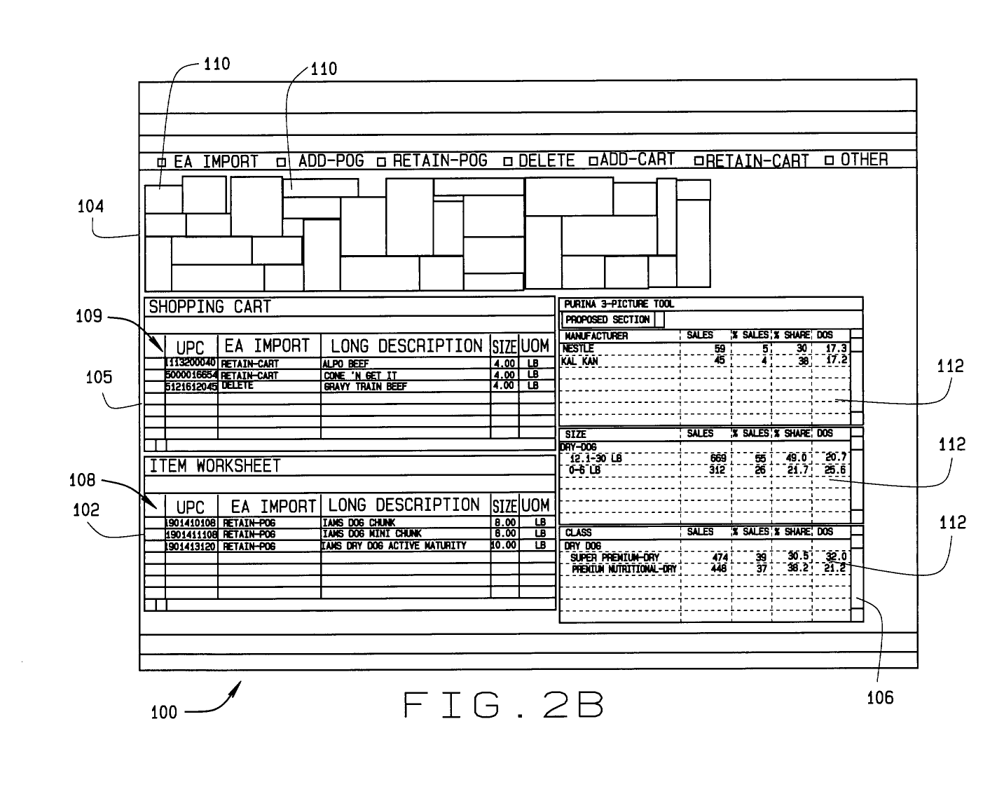

As shown in FIGS. 2(a) and 2(b), the electronic interface 100 (e.g., a GUI displayed on a monitor of a computer system) of the present invention includes various panels, each displaying information relating to a particular group of products that make up a shelf set. When used herein, a shelf set refers to the set of products together selected for display on a retail shelf. The electronic interface 100 includes an item worksheet panel 102, a planogram panel 104, a shopping cart panel 105 (shown only in FIG. 2(b) and minimized in FIG. 2(a)) and a dashboard panel 106. It should be noted that depending upon the desired or needed information for display on the electronic interface 100, the various panels may be resized, minimized or closed in a known manner. Further, additional or different panels may be provided, including for example, a shelf worksheet panel 107 as shown in FIG. 19 that provides physical shelf information (e.g., shelf dimensions and positions of products within the physical shelves).

The item worksheet panel 102 generally includes a list 108 of products from which a user may select specific products to include in a particular shelf set, and that will be displayed on the planogram panel 104. The list 108 includes information regarding each of the products, including, for example, UPC code, product description, size, color, manufacturer, category and segment. The list 108 also includes an indication as to whether a particular product is to be retained or deleted.

The planogram panel 104 includes a representation of a particular shelf set showing the specific products selected from the list 108 for display on a shelf (e.g., display on a retail shelf in a grocery store). In the embodiment shown, which is using Apollo, the specific products are represented by icons 110 that are preferably color coded, and may include an indication (e.g., a letter code) of the manufacturer of that product. It should be noted that the present invention may be implemented using different shelf management tools to allow for integration of efficient item assortment processes therewith.

The shopping cart panel 105 generally includes a list 109 of products, and in particular products that are to be deleted or added to the planogram as displayed in the planogram panel 104 and described in more detail herein. Further, products with UPCs that do not match with products listed in the item worksheet panel 102 will be provided in the list 109. The list 109 includes information regarding each of the products, including, for example, UPC code, product description, size, color, manufacturer, category and segment. The list 108 also includes an indication as to whether a particular product is to be deleted or added.

The dashboard panel 106 provides integrated information related to the products selected by a user (e.g., by using a computer mouse and clicking on specific products in the item worksheet 108) and displayed in the planogram panel 104. This integrated information preferably includes financial information that is updated based upon a change to the products selected (e.g., an add, delete or replace). The financial information is preferably divided into three general categories displayed in separate sub-panels 112. In the embodiment shown in FIGS. 2(a) and 2(b), the general categories include Manufacturer, Size and Class. Within each of these categories, specific information regarding the products selected and that are displayed in the planogram panel 104 is provided, and may include, for example, total sales volume, percent of sales based upon all products in the category, percent share based upon all products in the category, and days of product supply on shelf.

Using SKUs (Stock Keeping Units), a user can select specific products for display on a particular shelf and is provided with current financial information about the selected products in the dashboard panel 106. Using the interface 100 of the present invention, the particular shelf set may be modified (e.g., add, delete or change products) to manipulate expected or predicted sales or other financial data as described herein. Using financial reporting, the present invention allows a user to easily select a particular group of products for a shelf set.

Using the interface 100 as described above product selection may be made using information updated based upon the specific products selected for display, with changes to the selection causing the interface 100 to update the information. Specifically, and as shown in FIG. 3, efficient assortment (EA) data is gathered at step 120, which includes sales and other information relating to products of interest. This information is input into a database or efficient item assortment program, such as described in co-pending U.S. application Ser. No. ______ entitled “System and Method of Providing Efficient Item Assortment” filed on Oct. 24, 2002 (attorney docket number 5190-000009/US), the entire disclosure of which is incorporated herein by reference. This information is updated as necessary, such as, at predetermined time intervals (e.g., once a month). The EA data is then exported to a shelf management program (e.g., Apollo Suite 8.0) at step 122. The export of the EA data may include all or a portion of the data, which may include both updated and non-updated product information. Further, this exporting of data may be provided in any known manner and modified based upon the particular shelf management program being used.

A hierarchy level as described in more detail herein is selected at step 124 and a planogram file selected at step 126. As used herein, a planogram is a schematic representation (e.g., on a GUI) of a display section, which may include one or more shelves. The planogram may display shelves, uprights and products depending upon the particular program used. All of the products in a section typically fall within a single product category (e.g., dog or cat products).

The planogram file is then opened at step 128, which may include opening a custom report. The EA data is then imported into the planogram at step 130. This may include updating the product information based upon updates to the EA data. Such updating also updates the data displayed in the dashboard panel 106. The updating may be provided either automatically (e.g., after a change) or manually (e.g., selected by a user). Information relating to the products as displayed in the item worksheet panel 102 is also updated at step 132. Products are preferably defined and identified by a UPC number (i.e., 10-15 digit numerical code unique to each product), which is used to access information regarding the products from the database.

Modifications to the planogram in the planogram panel 104 may then be made at step 134, and can include, for example, product adds, retains and deletes. This will cause the information in the dashboard panel 106 to be updated. The item worksheet is thereafter updated at step 136, which may include updating of the shopping cart panel 105. An item detail exception report is then generated at step 138 as described herein.

Using the interface 100 and based upon updates and changes made to the planogram, reports are generated at step 140. In generating a report, a baseline for the planogram is selected at step 142, a customized financial report is then refreshed at step 144 based upon the changes, the customized financial report is exported (e.g., electronically) at step 146 and then may be printed at step 148 to provide a hard copy version.

An item worksheet may include different types of information regarding the products on the shelves in a current section and is not limited to the specific information described above, which is specific to the Apollo Suite 8.0 Item Worksheet. For example, the Apollo Suite 8.0 program includes a PMaster worksheet that is a spreadsheet containing information about products in a PMaster database, which is current EA information. Further, the term shelf as used herein refers to a physical component of a section, and may be provided in different configurations, including, for example, a standard shelf, a pegboard or a “coffin case”.

Having described generally the process for importing and using data with the interface 100, one preferred embodiment of the present invention provides the functionality for evaluating a shelf section as represented by a planogram, and viewing information when changes are made to the products selected. The interface will now be described as implemented in connection with Apollo co-pending application identified above. However, it should be recognized, that this is merely an exemplary implementation of the present invention, and different functionality may be provided in connection with this or different shelf management programs and item assortment programs. For example, software changes, additions or modifications may be implemented.

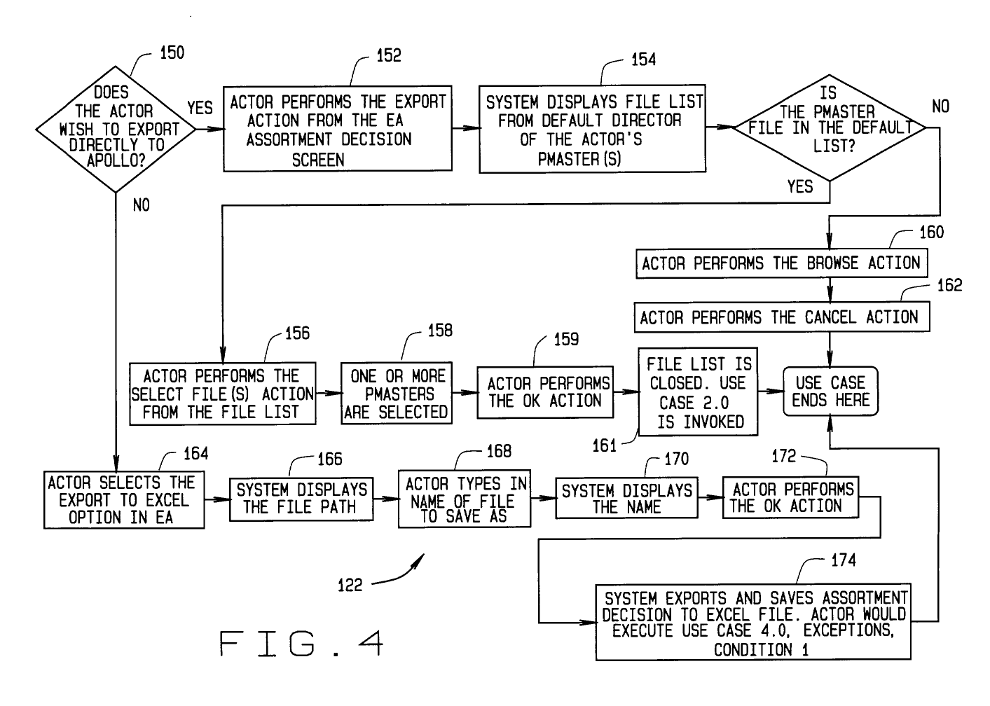

Referring to FIG. 4, when exporting EA data, a determination is first made at step 150 as to whether a user wants to export the data directly to Apollo. If a direct export is desired, an export action is performed at step 152. This may be provided, for example, from an assortment decision screen in the item assortment program. A file list is then displayed from a default directory at step 154. If the file of interest is in the list, then the file(s) are selected at step 156 and specific PMasters are selected at step 158, with a user confirming the selection at step 159 and the file list closed at step 161. If the file of interest is not in the list, a browse action is performed to attempt to locate the file(s) at step 160. The export process may be cancelled at step 162. Otherwise, the file(s) is exported at step 174.

If the user does not want to export directly to Apollo at step 150, other options may be provided. For example, at step 164 the user may select to export to a spreadsheet (e.g., Excel spreadsheet) by saving the file to specific directory for future reference at steps 166, 168, 170 and 172. The data is then exported and saved at step 174.

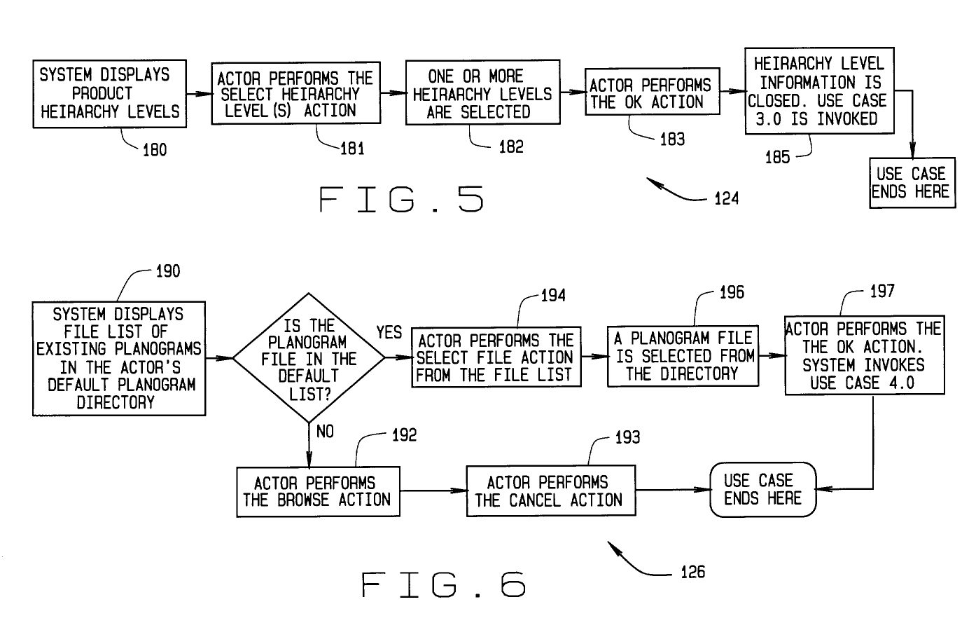

Once the EA information has been exported (i.e., specific PMaster selected and exported) and as shown in FIG. 5, different product hierarchy levels are displayed at step 180. One or more hierarchy levels are then selected by a user at steps 181 and 182. The user confirms the selection at step 183 and the hierarchy levels are closed at step 185. Once the hierarchy levels are selected a planogram file is selected as shown in FIG. 6. A list of planogram files that exist in a default directory is provided and displayed at step 190. If the planogram of interest is not in the directory, a user can browse other directories at step 192 in an attempt to locate a specific planogram file. If the planogram file is still not located, a user may cancel the action at step 193. If a planogram file is located then a user selects the specific planogram file at step 194 for loading into the planogram panel 104 at step 196. A user confirms selection of the planogram file at step 197.

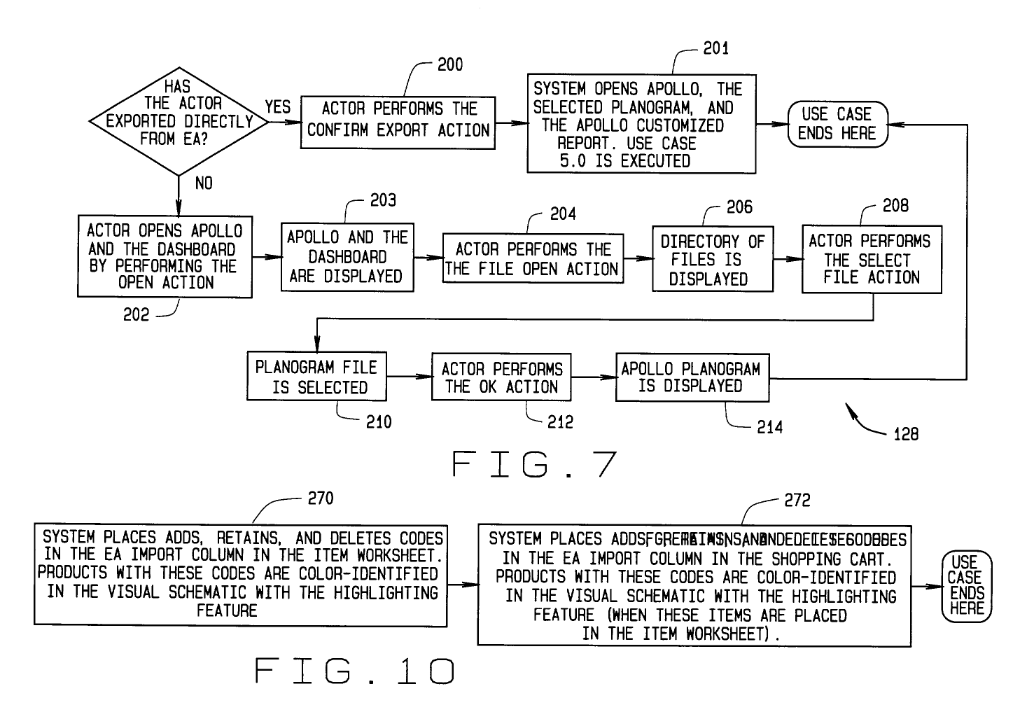

Thereafter, and as shown in FIG. 7, if a direct export action to Apollo was previously selected, then the Apollo program is activated, the selected planogram displayed in the planogram display panel 104 and an Apollo customized report generated at step 201 upon the user confirming an export action at 200. If a direct export action was not selected, then the user activates Apollo at step 202, which caused Apollo, including the interface 100 and dashboard panel 106 to open at step 203. The user then performs a file open action at 204. A directory of files is displayed at step 206 and a specific planogram file selected at step 208 and 210. A user then confirms the selection at step 212 and the planogram file is displayed at step 214 as described herein.

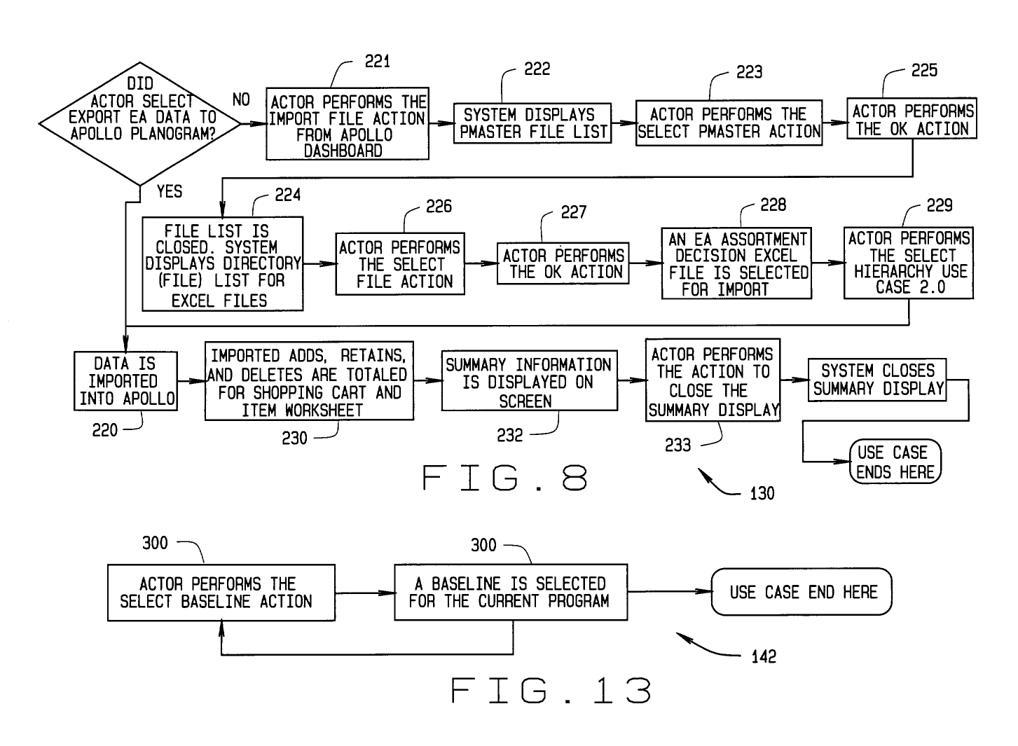

Once a planogram file is selected, and as shown in FIG. 8, EA data relating to the products is imported into Apollo at step 220 if a PMaster file was selected. If no PMaster file was selected, a PMaster list is displayed at step 222, which is initiated by a user at step 221, and a user may select a file therefrom at step 223 and confirm the selection at step 225. A user may select a file from a list of other files (e.g., Excel files) at steps 224 and 226, confirm the selection at step 227, which selects the file for import at step 228 and is then imported into Apollo at step 229. Once a file is imported, at step 230, any updates to products (e.g., updated EA information relating to particular UPCs) are provided to and displayed in the item worksheet in the item worksheet panel 102. Summary information is thereafter displayed at step 232 to confirm changes. A user the closes the summary display at step 233.

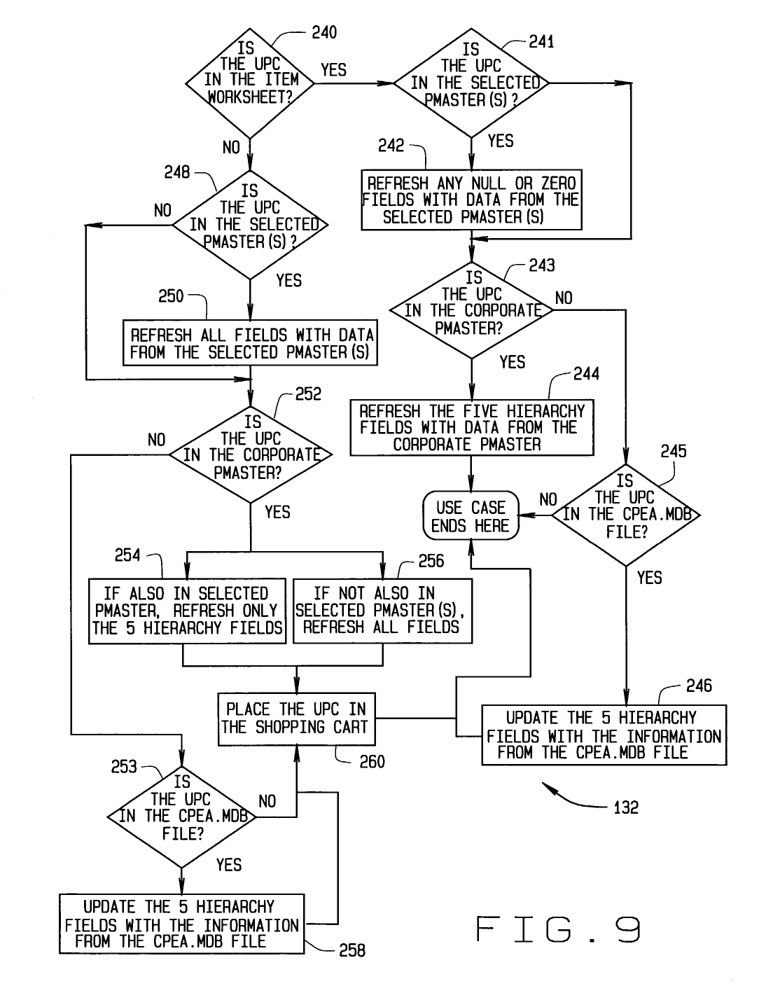

With respect to updating product information in the item worksheet, and as shown in FIG. 9, a determination is made as to whether a particular UPC is in the worksheet at step 240. If it is determined at step 241 that the UPC is in the selected PMaster file, then the product data is updated at step 242. A corporate PMaster file may be provided and updated at step 244 if the UPC is included therein as determined at step 243. Other files may also be updated if needed (e.g., update UPC at step 246) if such an update is determined to be needed at step 245.

If the UPC is not in the item worksheet, a determination is made at step 248 as to whether the UPC is in the selected PMaster file. If it is, then all fields relating to that UPC are updated at step 250. If it is not, then a determination is made as to whether the UPC is in the Corporate PMaster file at step 252. If it is, and it is also in selected PMaster file, then only the five hierarchy fields are updated at step 254. If it is, but it is not in the selected PMaster file, then all fields are updated at step 256.

If the UPC is not in the Corporate PMaster file, then a determination may be made at step 253 as to whether it is in another file (e.g., cpea.mdp file). If it is, then the 5 hierarchy fields are updated from that file at step 258. If not, then the UPC is placed within the shopping cart at step 260.

After the updates are performed, the UPC is placed within the shopping cart at step 260.

Thereafter, and as shown in FIG. 10, changes to product information are displayed at step 270 within the item worksheet panel 102. Add, retain and delete codes are provided within the item worksheet (e.g., EA import column). Color coding is preferably also provided in the schematic representation of products in the planogram in the planogram panel 104 for easier identification. The same codes are also provided to the shopping cart at step 272.

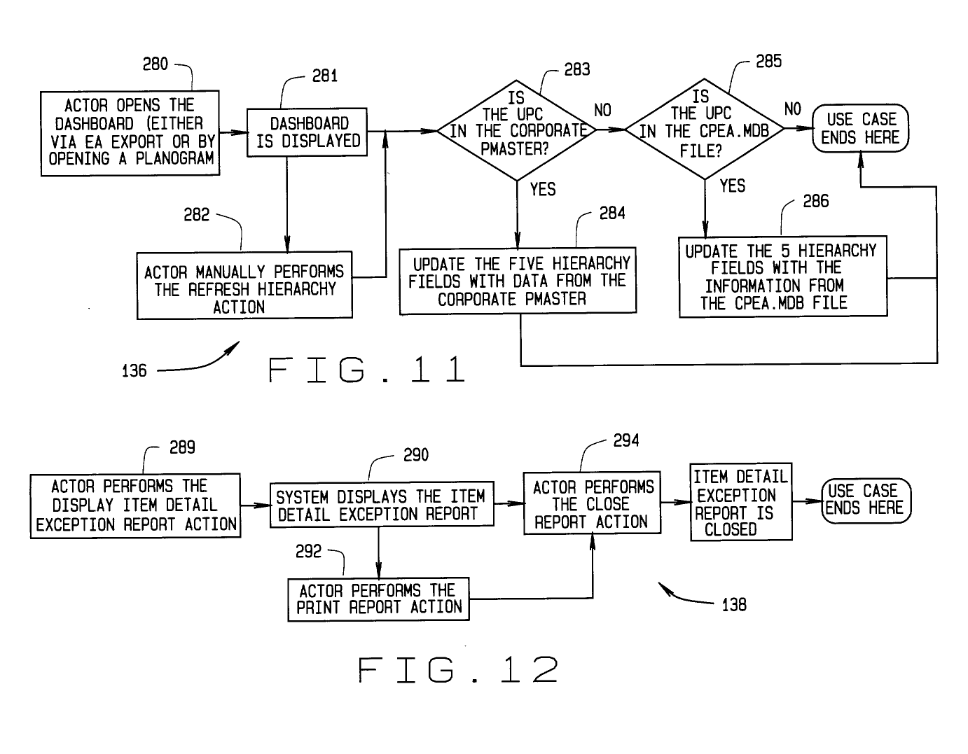

Once the codes are updated, and as shown in FIG. 11, a user accesses (i.e. opens on the screen) at step 280 the dashboard panel 106, which is displayed at step 281. If the UPCs from the item worksheet and shopping cart are in the Corporate PMaster file as determined at step 283, the 5 hierarchy fields are updated from the Corporate PMaster at step 284. If not, and if the UPCs are in another file (e.g., cpea.mdb file) as determined at step 285, then the 5 hierarchy fields are updated from that file at step 286. A user may manually perform a hierarchy refresh (i.e., update) at step 282 if desired.

An Item Detail Exception Report is generated at step 290 when initiated by a user at step 289 as shown in FIG. 12 and provides a report showing required fields that do not contain necessary data. A hard copy of the report may be printed at step 292, with a user closing the report action at step 294. A user may select a new baseline for comparison at step 301 by selecting a baseline action at step 300 as shown in FIG. 13. The user may change this baseline value to perform different comparisons.

Once all the product information has been updated, including adds, deletes and retains to particular products identified by their UPC code, and a baseline selected, an update action is performed at step 311, which is initiated by a user at step 310 as shown in FIG. 14, to update the planogram in the planogram panel 104 accordingly. A user may select automatic refresh, in which case, the system refreshes custom reports since the last refresh at step 312. Otherwise, at step 314 a manual refresh is performed. The customized reports are displayed within the dashboard panel 106 and include financial information relating to the products displayed in the planogram in the planogram panel 104 and as described herein. A user can then make changes to the planogram (e.g., add, delete, retain or replace products) and thereafter view updated financial information in the dashboard panel 104 based upon the changes made and as compared to the selected baseline.

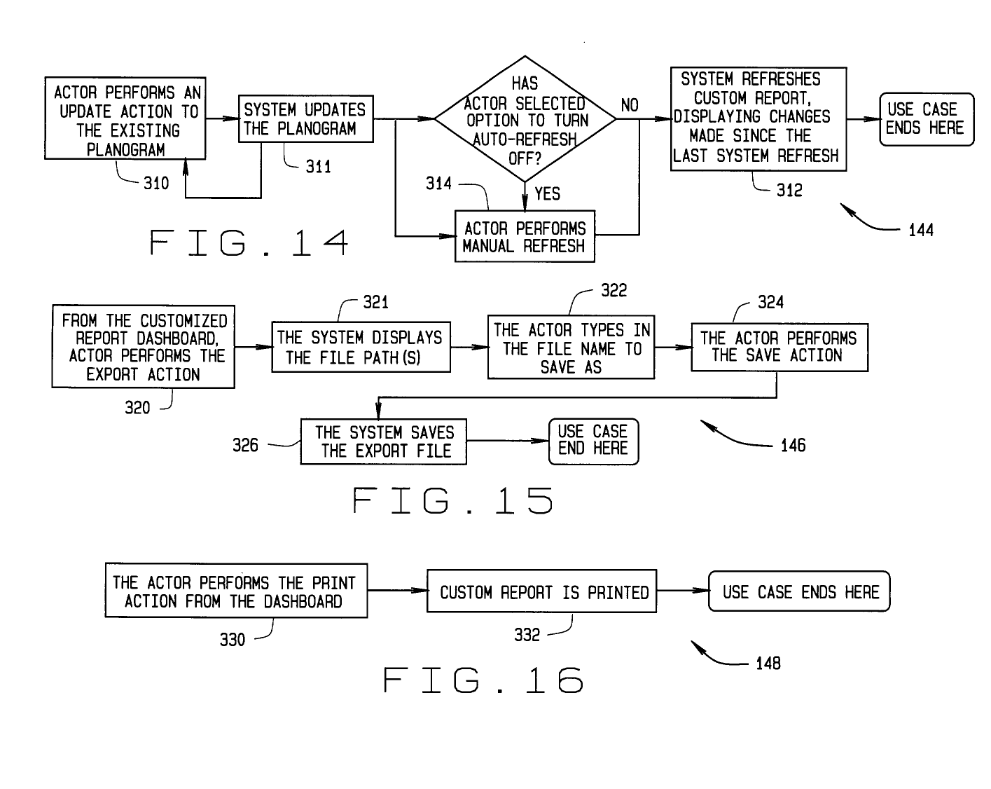

Once a user has determined that a particular planogram is in final form (e.g., has been optimized), an export action may be performed at step 320 as shown in FIG. 15. A file path is displayed at step 321. A file name is selected at step 322 and a save action performed at step 324. The export file is then saved at step 326. Thereafter, and as shown in FIG. 16, a print action may be performed at step 330, with a custom hard-copy of the report printed at step 332.

Changes made to the products selected for a particular shelf set and displayed as a planogram in the planogram panel 104 may be made prior to importing the updated information or thereafter, using the dashboard panel 106 to determine the effects of any such changes.

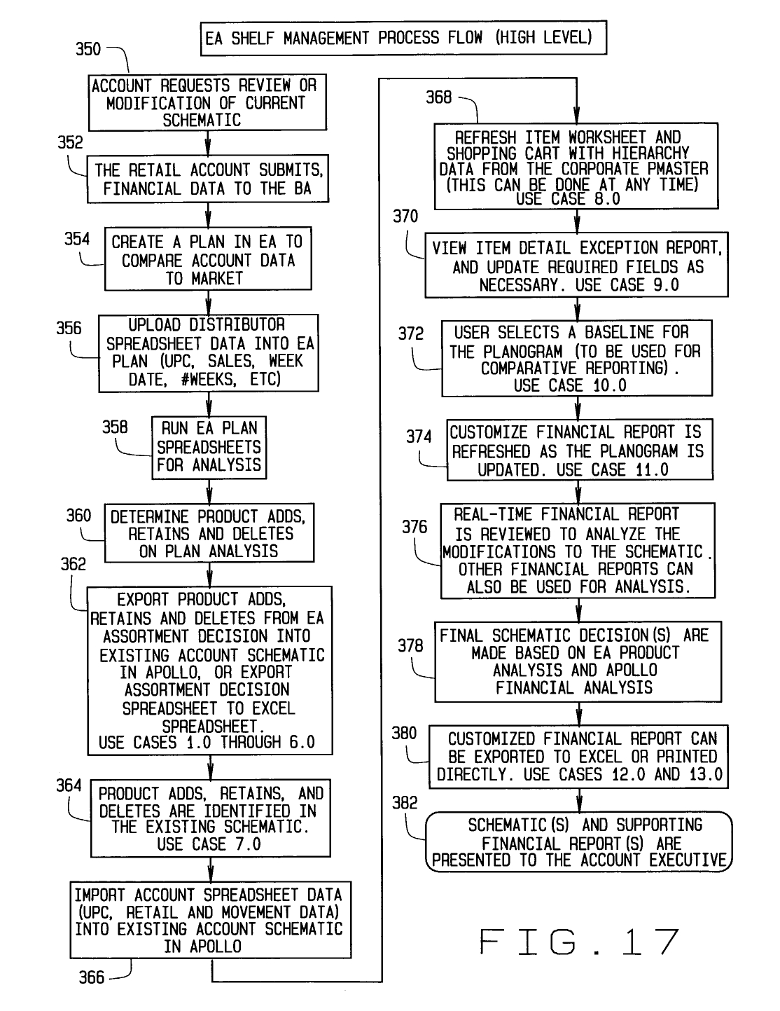

In operation, and as shown in FIG. 17, a typical process for determining specific products to display on a shelf set begins with a request to review or modify a current shelf set at step 350. Financial data is submitted 352 and a plan is created in an item assortment program at 354. Updated information is thereafter imported into the item assortment program at step 356, which may include, information relating to, for example, sales data and DOS information. Specific spreadsheets showing this updated information then may be generated at step 358 using the item assortment program and a determination thereafter made at step 360, based upon the updated information, whether products adds, retains or deletes are necessary based upon the plan analysis. This determination may be made based upon predetermined rules used to maximize, for example, product share.

Product changes (e.g., product adds, retains and deletes) are then exported at step 362 from the item assortment program into a shelf management program (e.g., Apollo) or spreadsheet as described herein and identified in FIG. 3 as steps 122, 124, 126, 128, 130, and 132. The product changes are identified in the interface 100 at step 364, identified as step 134 in FIG. 3, and as described herein. At step 366 product update information is imported into the shelf management program. The item worksheet and shopping cart are updated with hierarchy data from the Corporate PMaster at step 368, identified in FIG. 3 as step 136. This step may be performed at any time and as needed.

Required fields are then updated at step 370, identified in FIG. 3 as step 138, based upon the Item Detail Exception Report. A baseline level for comparison is then selected at step 372, identified in FIG. 3 as step 142. Based upon the changes to the products from the EA process, including the plan analysis, a customized financial report is updated at step 374, identified in FIG. 3 as step 144 and displayed in the dashboard panel 106. Using the dashboard panel 106, financial data is reviewed at step 376 to analyze the modifications to the shelf set as represented and displayed as a planogram in the planogram panel 104. Additional or different information may be provided in the dashboard panel 106 depending upon particular requirements or the specific options available using the shelf management program.

Using the financial data displayed in the dashboard panel 106, changes to the products selected for the shelf unit may be made with updated financial information provided in the dashboard panel 106. A final shelf set may then be selected at step 378 with financial reports relating to the finalized shelf set printed at step 380, identified in FIG. 3 as steps 146 and 148. These financial reports may then be presented for approval at step 382.

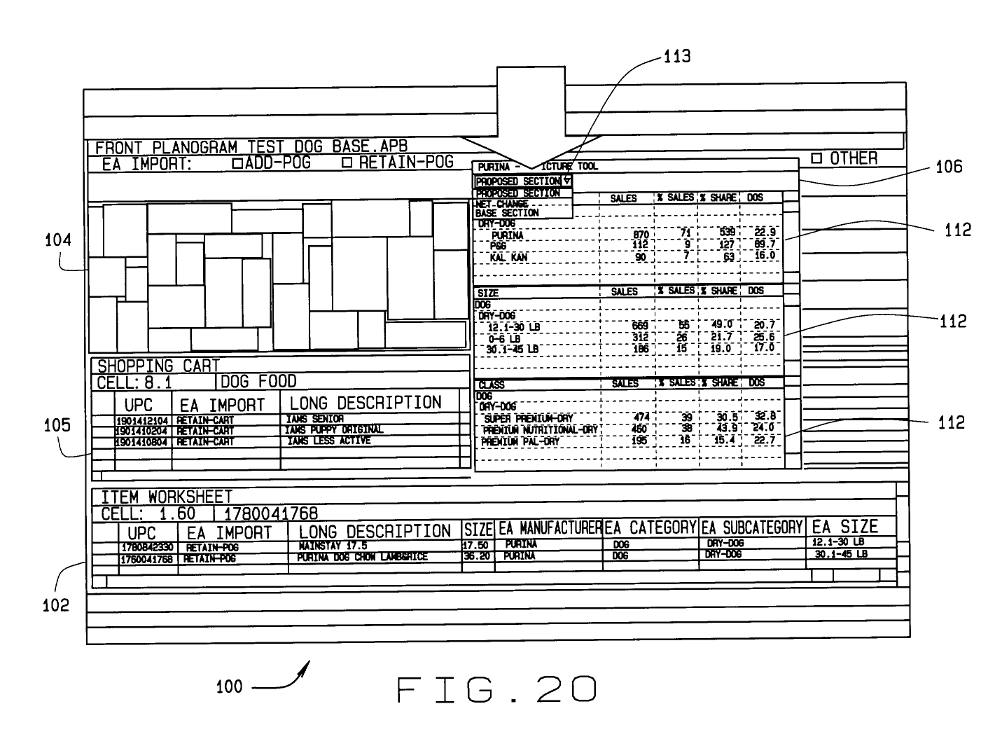

Using the dashboard panel 106, and as shown in FIG. 20, a pull-down menu 113 may be provided to allow for selection of different updated financial information based upon changes to a shelf set, including financial information for a base section (i.e., original shelf set), a proposed section (i.e., new shelf set with adds, deletes and maintains performed) and a net change showing the change to the financials for the products in the planogram in the planogram panel 104 based upon changes (i.e., adds, deletes and retains) to the products selected for display. In combination with the financial information preferably displayed in three main categories (i.e., Manufacturer, Size and Class), changes to % Sales, % Share and DOS resulting from changes to the products selected for the particular shelf set shown in the planogram panel 104, may be analyzed to optimize the set of products selected for the shelf set. For example, when performing an analysis of financial information provided in a particular category in the dashboard panel 106, comparison of the % Share and % Sales columns may be performed to determine whether to increase or decrease the quantity of a specific product in the shelf set. In comparing this financial information, if the % Share is greater than the % Sales for a particular product, the number of that product on the shelf may need to be reduced. If the % Share is less than the % Sales for a particular product, the number of that product on the shelf may need to be increased. It should be noted that other comparisons may be performed, including using other financial information (e.g., DOS) in the dashboard panel 106.

Thus, the interface 100 of the present invention allows for a benchmark analysis of a particular shelf set using financial information displayed by category (e.g., DOS by UPC, Size Segment and Manufacturer, and share of the shelf by Size Segment and Manufacturer) as shown in the dashboard panel 106. For example, average days of inventory for different products can be compared, and a determination made as to changes in the averages if new products are added. Further, adds and deletes of SKUs may then be performed, and when positioning the SKUs, the UPC DOS may be reviewed (e.g., using a status bar at the bottom of the screen). Once the add/deletes are updated (i.e., imported from item assortment program), a user can modify the shelf unit represented as a planogram by looking at the dashboard panel 106 to determine the effects of the changes on the DOS and share of shelf for the overall of the section, size segment and manufacturer. Additional changes may then be made. A final (i.e., optimized) shelf set is then provided that increases sales and profit. Different financial data and factors may be analyzed using the interface 100 with effects to the financial data from changes to the products selected easily determined.

Dynamic financial reporting is provided that allows for a analysis and determination as to the products to include on a particular shelf set. More preferably, an efficient item assortment process is performed using an Efficient Item Assortment program to determine a specific set of products to include on a shelf set and an interface 100 of the present invention provides for evaluating changes to the set of products, including for example, the quantity of each product provided as part of the shelf set using financial information updated based upon the changes.

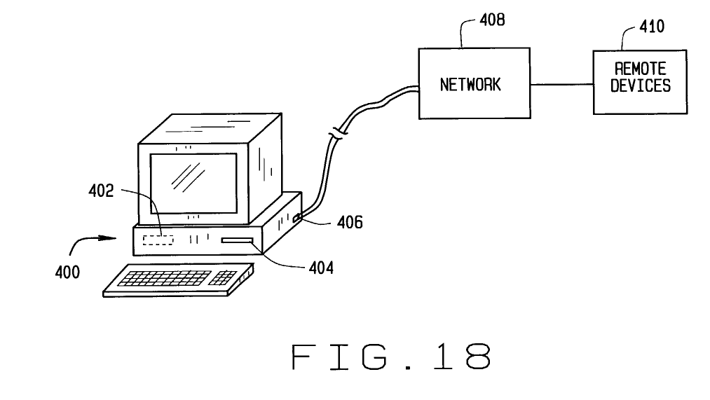

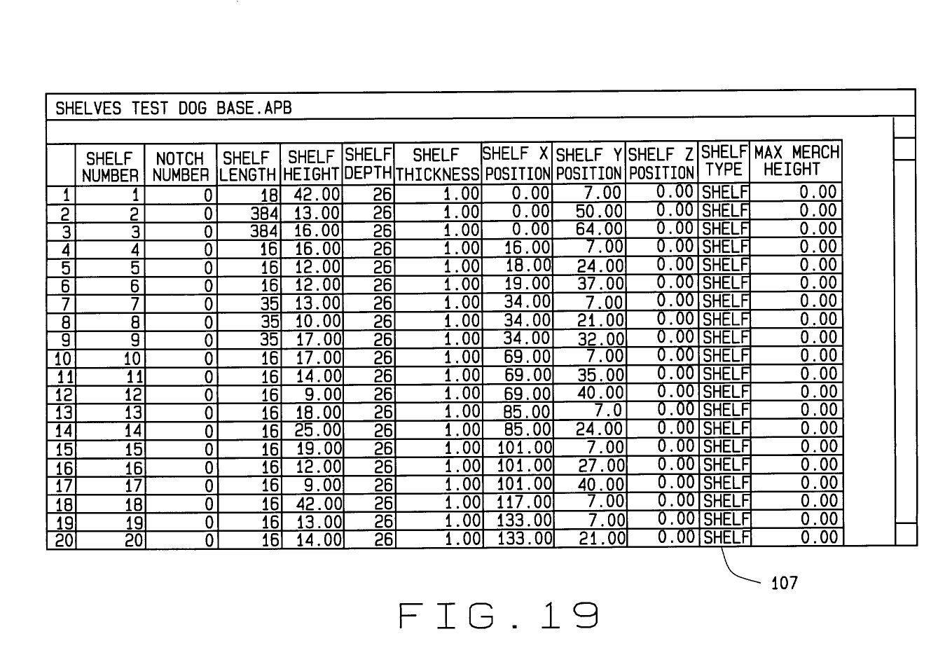

The present invention may be implemented on any computer readable medium capable of causing a computer to provide the interface 100. The computer readable medium includes, but is not limited to, a floppy disk, a CD-ROM, a magnetic tape, a hard-disk drive, flash memory and random access memory (RAM). In particular and as shown in exemplary form in FIG. 18, a computer 400 may include an internal storage device 402 (e.g., hard-disk drive) for storing instruction for implementing the interface 100 and/or an external reading device 404 (e.g., floppy disk drive) for receiving a computer readable medium (e.g., floppy disk) having instructions recorded thereon for causing a processor of the computer 400, upon executing the instructions to provide the interface. A network interface 406 (e.g., local area network (LAN) connection) may also be provided as part of the computer 400 to allow for communication with a network 408 having remote devices 410 also connected thereto. The network interface 406 allows for communication of the interface 100 to the network 408 and connected remote devices 410. The present invention may be implemented using one or more different programming languages and selection of a particular operating system or platform determined by one of ordinary skill in the art, including, for example, a designer or programmer.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for integrating and displaying information to assist a user in selecting an assortment of retail products for display on a shelf, the method comprising:
receiving electronic item assortment information for each of the retail products;
receiving electronic shelf management information for each of the retail products; and
processing the received electronic item assortment information and electronic shelf management information to produce one of forecasted sales information and forecasted supply information; and
displaying the one of the forecasted sales information and forecasted supply information in combination with a representation of the assortment of retail products for display on the shelf.

2. The method according to claim 1 further comprising updating the forecasted sales information and forecasted supply information in response to a user's modification of the selection of the assortment of retail products for display on the shelf.

3. The method according to claim 1 further comprising updating the forecasted sales information and forecasted supply information in response to a modification of the electronic item assortment information.

4. The method according to claim 1 further comprising updating the forecasted sales information and forecasted supply information in response to a modification of the electronic shelf management information.

5. The method according to claim 1 further comprising adding representations of retail products to the assortment of retail products for display on the shelf and updating the forecasted sales information and forecasted supply information based upon the added representations of retail products.

6. The method according to claim 1 further comprising deleting representations of retail products from the assortment of retail products for display on the shelf and updating the forecasted sales information and forecasted supply information based upon the deleted representations of retail products.

7. The method according to claim 1 further comprising changing representations of retail products to the assortment of retail products for display on the shelf and updating the forecasted sales information and forecasted supply information based upon the changed representations of retail products.

8. The method according to claim 1 wherein the forecasted sales information comprises product share information.

9. The method according to claim 1 wherein the forecasted supply information comprises days of product supply on shelf information.

10. The method according to claim 1 further comprising using predetermined rules to determine specific retail products for display on the shelf.

11. The method according to claim 1 wherein the retail products comprise animal food products.

12. The method according to claim 1 wherein the retail products comprise pet food products.

13. A method for assisting a user in selecting a plurality of products for display on a retail shelf using a computer, the method comprising:
displaying on a display of the computer a representation of an arrangement of products selected for display on the retail shelf;
receiving item assortment information and shelf management information relating to the products represented on the display; and
displaying one of predicted financial information and predicted supply information relating to the representation of products in response to the received information.

14. The method according to claim 13 wherein the shelf management information comprises quantity information relating to at least some of the products represented on the display.

15. The method according to claim 13 wherein the predicted financial information comprises predicted sales information.

16. The method according to claim 13 further comprising updating the displayed predicted financial information and predicted supply information in response to modification to the received information.

17. A computer implemented method for processing electronic item assortment information and electronic shelf management information to produce one of forecasted sales information and forecasted supply information for use in assisting a user in selecting an assortment of products for display on a shelf, the method comprising:
receiving electronic item assortment information for each of the products;
receiving electronic shelf management information for each of the products;
processing the received electronic item assortment information and electronic shelf management information to display a representation of an arrangement of products on a shelf and display predicted sales information and predicted supply information related to the products; and
updating the displayed predicted sales information and predicted supply information in response to a modification to the representation.

18. The computer implemented method according to claim 17 wherein the updating is performed automatically in response to the modification.

19. The computer implemented method according to claim 18 wherein the predicted sales information comprises predicted product share information.

20. A system for integrating and displaying information relating to an assortment of retail products, the system comprising:
an interface for receiving electronic item assortment information and electronic shelf management information;
a processor configured to process the electronic item assortment information and electronic shelf management information to produce one of forecasted sales information and forecasted supply information for display in combination with a representation of the assortment of retail products; and
a user input provided in connection with the interface and configured to allow modification of the received electronic item assortment information and electronic shelf management information resulting in updating of the displayed forecasted sales information and forecasted supply information.

21. The system according to claim 20 wherein the forecasted sales information comprises forecasted product share information.
